(19) United States
(12) Patent Application Publication
(10) Pub. No.: US 2007/0282808 A1
(43) Pub. Date: Dec. 6, 2007

(54) Search processing method and apparatus

(75) Inventors: Masaki Hashirano, Kawasaki (JP); Osamu Matsumoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/517,368

(22) Filed: Sep. 8, 2006

(30) Foreign Application Priority Data
Jun. 5, 2006 (JP) 2006-155552

(51) Int. Cl. G06F 17/30

(52) U.S. Cl. 707/3

(57) ABSTRACT

This invention is provided to reduce a processing volume when extracting record sequences meeting the ordered plural search conditions. This invention includes: assigning a flag for each item value of a specific item based on a search instruction including plural ordered search conditions, wherein each search condition designates a specific value for the specific item, and storing the flags as flag definition data; sorting plural records to be searched; identifying a flag corresponding to an item value of the specific item in each record to be processing in order of the plural sorted records, by using the flag definition data; in a process of the identifying the flag in the order of the plural sorted records, judging whether an appearance mode of the identified flags follows the search instruction; and outputting data of records relating to the flags included in the appearance mode of the flags, which was judged to follow the search instruction.

### TECHNICAL FIELD OF THE INVENTION

This invention relates to a search processing technique for a database.

### BACKGROUND OF THE INVENTION

For example, U.S. Pat. No. 6,643,644 discloses a following technique. Hereinafter, a case where data of a relational database (RDB) as shown in FIG. 1 exists will be explained, specifically. FIG. 1 shows portion of a sales history table, and the sales history table includes 19 records having respective item values for respective items (attributes) that are a customer ID, date and time, a product, a price, and a store code. Incidentally, “rowid” indicates a line number (also called a record number) as a matter of convenience of the description.

The data as shown in FIG. 1 is held as data as shown in FIG. 2 in the aforementioned Japanese Patent. That is, the data includes a ROOT array 9001, a POS array 9002 and a value table 9003 concerning an item of the customer ID, a POS array 9004 and a value table 9005 concerning an item of the date and time, a POS array 9006 and a value table 9007 concerning an item of the product name. The ROOT array 9001 is an array to hold line numbers to be referenced in each POS array. As for the customer ID, the value table 9003 uniquely identifies item values (001 to 007) of the customer ID, and the POS array 9002 holds, in each line (i.e. position), a pointer to a line of the value table 9003 to be referenced with respect to a record whose record number is stored in a corresponding line in the ROOT array 9001. For example, when the first line of the POS array 9002 is to be processed, this is data for a record 1, and “1” held in the POS array 9002 indicates the customer ID “001” by referring to the first line of the value table 9003. Similarly, as for the date and time, the value table 9005 uniquely identifies item values (March 1 1st, 10:00 to March 9th, 19:00) of the date and time, and the POS array 9004 holds, in each line (i.e. position), a pointer to a line of the value table 9005 to be referenced with respect to a record whose record number is stored in a corresponding line in the ROOT array 9001. Also as for the product name, the value table 9007 uniquely identifies item values (DVD Software to Refrigerator) of the product name, and the POS array 9006 holds, in each line (i.e. position), a pointer to a line of the value table 9007 to be referenced with respect to a record whose record number is stored in a corresponding line in the ROOT array 9001.

That is, a data structure is adopted in which, as for each item, a value table holding a relationship between an item value number uniquely identifying an item value and the item value, and an item value number designating information array storing information designating the item value number in order of the record are held.

By holding such a data structure, for example, in a case where records whose customer ID is “001” are extracted, the line number “1” of the line in which “001” is held is identified in the value table 9003, and the line numbers “1”, “2”, “10”, and “14” of the lines in the POS array 9002, which hold the identified line number “1”, are record numbers to be extracted.

Here, in the sales history table shown in FIG. 1, a search is considered in which customers who purchased “HDD recorder”, “DVD player” or “TV (Television)”, purchased any “software” after that, and further purchased “DVD-R” or “CD-RW” are extracted.

Although the aforementioned patent does not directly disclose such a search method, it is necessary to carry out a following procedure, normally. First, the data is sorted for each customer ID and in order of the date and time. As for the RDB as shown in FIG. 1, the sorting itself is difficult in a case where there is huge data volume. However, when the data structure as shown in FIG. 2 is used, it is possible to sort the data because the data volume is reduced. In order to make it easy to understand, the sorting result in a format of FIG. 1 is shown in FIG. 3, and the sorting result including only the record numbers is shown in FIG. 4. The sorting result of FIG. 4 is held as a SET array 9011, and the records are arranged in order of record 1, record 2, record 10, and record 14 . . . . This record number is also called SETID.

Then, as the first step, records corresponding to “HDD recorder”, “DVD player” or “TV” are extracted. In such a case, as shown in FIG. 5, in sequential order of the SET array 9011, the POS array 9006 for the product name is referenced to read out the corresponding item value number, and the item value at a position of the item value number is identified in the table 9007 to judge whether or not the aforementioned first condition is met. The first record number in the SET array 9011 is “1”, and “5”, which is the first item value number in the POS array 9006, is identified. Then, “TV”, which is the fifth item value in the table 9007, is read out. Therefore, the aforementioned first condition is met, and the record number “1” is extracted. For example, the third record number in the SET 9011 is “10”, and “1”, which is the 10th item value number in the POS array 9006, is identified. Then, “DVD software”, which is the first item value in the table 9007, is read out. Therefore, the aforementioned first condition is not met, and the record number “10” is not extracted. Such a processing is repeated.

Then, a SETID sequence like an array 9021 shown in FIG. 6 is obtained. Because it is not easy to understand the specific content only by the array, the specific content of the extracted records is shown in a table 9022. However, because it is unknown only by this data whether or not the second condition is met, the data of the SET array 9011 must be referenced, again.

Specifically, when the record numbers are obtained from the array 9021 of FIG. 6, the next arranged record numbers are identified in the SET array 9011 of FIG. 4. For instance, in a case of the record number “1”, the record number “2” is identified. Then, the POS array 9006 for the product name is referenced to read out the item value number at a position of the identified record number, and the item value at a position of the item value number is identified in the table 9007 to judge whether or not the aforementioned second condition is met. When the record number “2” is identified, “4”, which is the second item value number in the POS array 9006, is read out. Then, “HDD recorder”, which is the item value at the position of the item value number “4”, is identified, and compared with “software” that is the second condition. In this case, it is judged that the second condition is not met. Similarly, when the second record number “2” in the array 9021 is to be processed, the next record number in the SET array 9011 is “10”. The 10th item value number “1” of the POS array 9006 is read out according to the record number “10”, and “DVD software”, which is the item value at the position of the item value number “1”, is identified in the table 9007 and compared with “software” that is the second condition. In this case, it is judged that the second condition is met.

The aforementioned processing is summarized in FIG. 7. FIG. 7 shows a SET array 9031 for the next records, a corresponding data table 9032, and a POS array 9006 and a value table 9007 for the item of the product name. In the SET array 9031 and the data table 9032 for the next records, the second condition is not met in the hatched lines, and as a result, the records numbers “10”, “9” and “17” are extracted.

Incidentally, although the description is omitted, because the same customer must meet the first to third conditions in this order, at least three records are necessary for one customer, and when there is no next record, such a customer is not processed. For example, the last line in the SET array 9031 for the next records indicates a case where the next record does not exist, and “−” is recorded.

Thus, even when the array 9021 storing the records numbers meeting the first condition is extracted, it is necessary to access the SET array 9011 again in order to extract the next records, and it is also necessary to confirm whether or not the SET array 9031 for the next array 9031 meets the second condition, again.

Furthermore, in order to confirm whether or not the third condition is met, the data of the SET array 9011 must be referenced again.

Specifically, for each of the record numbers “10”, “9” and “17”, which are not hatched in the SET array 9031 for the next records, which is shown in FIG. 7, the next arranged record number is identified in the SET array 9011, again. For example, the next record number of the record number “10” is “14” as shown in a SET array 9041 for the next and next records of FIG. 8, and the next record number of the record number “9” is “18”, and the next record number of the record number “17” does not exist, as shown in FIG. 8.

Next, by referring to the POS array 9006 for the product name, the item value numbers are read out at positions of the identified record numbers, and the item values at positions of the read item value numbers are identified to judge whether or not the aforementioned third condition is met. That is, the item value number “2” is read out at a position of the record number “14” in the POS array 9006, the item value “DVD-R” corresponding to the item value number “2” is identified in the value table 9007 and compared with the aforementioned third condition, and it is judged that this record meets the third condition. In addition, the item value number “2” is read out at a position of the record number “18” in the POS array 9006, the item value “DVD-R” corresponding to the item value number “2” is identified in the value table 9007 and compared with the aforementioned third condition, and it is judged that this record meets the third condition.

That is, a sequence of the record numbers “2”, “10” and “14” with respect to the customer ID “1”, and a sequence of the record numbers “6”, “9” and “18” with respect to the customer ID “4” are extracted.

Thus, even if the array (i.e. portion of the SET array 9031 for the next records) storing the record numbers, which meet the second condition, it is necessary to access the SET array 9011 again in order to the next record, and it is also necessary to confirm whether or not the SET array 9041 for the next and next records meets the third condition, again.

Although the number of matching times does not increase too much if the number of records is small, it is necessary to judge, many times for each record, whether or not it matches the conditions. Therefore, there is a problem that the number of matching times becomes huge when the number of records is huge.

Incidentally, JP-A-2000-20527 discloses a technique to enhance the search speed by switching storage methods of line position information to re-use the search result of the conditional search based on hit rates of the search to minimize the necessary area. Specifically, when a database management program finds out a search condition, which matches a search being processed, in a search result management table at the search processing, the search for the database with respect to the matched search condition is treated as an unnecessary search by referring to the corresponding search result position information. However, this publication cannot resolve the aforementioned problem.

In addition, JP-A-2005-251002 discloses a technique in which the structure of the source database is conventional, and a re-search for a retrieval by adding more conditions or the like can be carried out even after a search result file has been generated. Specifically, data corresponding to a predetermined search condition is extracted from a database, and the search result file including locators indicating storage positions of the extracted data on the database is generated. At the re-search, by referring to the database by the locators, data for the re-search is obtained, and data corresponding to the re-search condition is extracted to generate a new search result file. This publication also cannot resolve the aforementioned problem.

As described above, the conventional techniques cannot reduce the number of matching times for huge records to enhance the processing speed in a processing to extract record sequences meeting plural ordered search conditions, which occur when extracting the purchase history or the like.

### SUMMARY OF THE INVENTION

Therefore, an object of this invention is to provide a technique to reduce the number of matching times for records when extracting record sequences meeting the ordered plural search conditions.

A search processing method according to this invention comprises: assigning a flag for each item value of a specific item based on a search instruction including a plurality of ordered search conditions, wherein each search condition designates a specific value for the specific item, and storing the flags as flag definition data into a storage device; sorting a plurality of records to be searched, which are stored in a database, according to a predetermined rule (e.g. time sequence); identifying a flag corresponding to an item value of the specific item in each record to be processing in order of the plurality of sorted records, by using the flag definition data stored in the storage device; in a process of the identifying the flag in the order of the plurality of sorted records, judging whether or not an appearance mode (e.g. an appearance order of the flags, continuity of the detection or the like) of the identified flags follows the search instruction; and outputting data of records relating to the flags included in the appearance mode of the flags, which was judged to follow the search instruction.

By carrying out such a processing, a processing in the conventional technique in which it is frequently judged whether or not the records in the database match the search condition is converted into a processing in which a record group in the database is converted into a flag sequence based on the search instruction, and it is confirmed whether or not the appearance mode of the flags follows the search instruction. Thereby, the number of matching processings is reduced and the entire processing becomes efficient.

In addition, the assigning may include: identifying an item value of the specific item, which corresponds to the specific value of the specific item in a specific search condition and is included in the record of the database; and assigning a flag according to the order of the specific search condition to the identified item value. Conventionally, it is necessary to judge may times for the same record whether or not the item value included in the search condition coincides or partially coincides with the item value in the record. However, when the aforementioned identifying the item value is carried out, the number of comparison times between the item values is limited to (the number of kinds of the item values included in the search condition)*(the number of kinds of the item values in the database) even in the largest case. Therefore, the processing is simplified and becomes efficient. In addition, when the aforementioned assigning is carried out, the flag represents the order. Therefore, it becomes easy to judge the appearance mode of the flag.

Furthermore, the aforementioned judging may include: judging, according to the identified flags, whether or not a transition between states defined according to the order occurs; and judging whether or not a final state is reached when the transition between the states occurs. Thus, by managing state transitions, it becomes possible to correctly and simply judge whether or not the appearance of the flags follows the search instruction. In addition, by appropriately defining the condition for the transition between the states, it is possible to treat various search instructions.

Incidentally, the aforementioned predetermined rule may be a condition including sorting for each group item designated by the search instruction, and sorting in time sequence order. In this case, the aforementioned judging may include judging the appearance mode of the flags within a range of the same item value of the group item. Such a processing is carried out for the search of the customer purchase history or the like.

Furthermore, the aforementioned database may have a table holding a relationship between an item value number uniquely identifying an item value and the item value, and an item value number designating information array storing information designating the item value number in order of the records. By using such a data structure, the sorting can be carried out simply and at high speed.

In addition, the aforementioned flag may be a bit string in which “1” is set at a bit position of the order of the corresponding search condition. It becomes possible to judge the appearance mode of the flag at higher speed.

Incidentally, when the aforementioned identifying the flag is carried out only once for the plurality of records to be searched, which are stored in the database, the number of matching times can be reduced.

Incidentally, it is possible to create a program for causing a computer to execute this method according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a diagram showing an example of a sales history table;

FIG. 2 is a diagram showing a data structure in a conventional art;

FIG. 3 is a diagram showing an example of a sorted sales history table;

FIG. 4 is a diagram showing an example of a sorted SET array;

FIG. 5 is a diagram showing a search processing in the conventional art;

FIG. 6 is a diagram showing a record group meeting the first condition;

FIG. 7 is a diagram showing the search processing in the conventional art;

FIG. 8 is a diagram showing the search processing in the conventional art;

FIG. 9 is a diagram showing an outline of a system according to an embodiment of this invention;

FIG. 10 is a diagram showing an input screen example of a search instruction;

FIG. 11 is a diagram showing a main processing flow according to the embodiment of this invention;

FIG. 12 is a diagram showing a processing flow of an event judgment processing;

FIG. 13 is a diagram showing an example of an event management table;

FIG. 14 is a diagram showing a first portion of a processing flow of a search processing according to the embodiment of this invention;

FIG. 15 is a diagram showing an initial state of an event history condition table;

FIG. 16 is a diagram showing a next state of the event history condition table;

FIG. 17 is a diagram showing a next and next state of the event history condition table;

FIG. 18 is a diagram showing an example of an event flag table;

FIG. 19 is a diagram showing an example of a state transition;

FIG. 20 is a diagram showing a second portion of the processing flow of the search processing according to the embodiment of this invention;

FIG. 21 is a diagram showing a utilization method of the event flag table;

FIG. 22 is a diagram showing an example of an extracted event table;

FIG. 23 is a diagram showing a specific example of the event flags and the state transitions according to the embodiment of this invention;

FIG. 24 is a diagram showing an example of an output result; and

FIG. 25 is a functional block diagram of a computer.

### DETAILED DESCRIPTION OF THE PREFERRED EMBODIMENTS

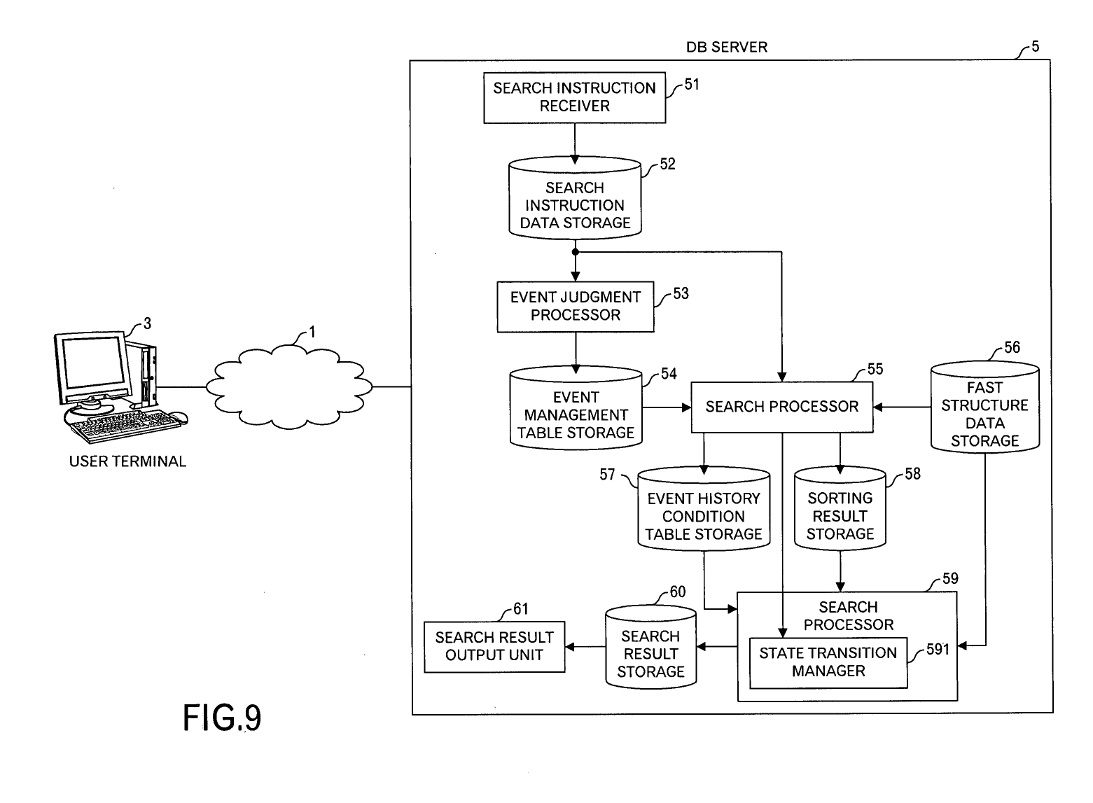

FIG. 9 shows a system outline figure according to one embodiment of this invention. For example, a network 1 such as a local area network (LAN) is connected to one or plural user terminals 3, and a database (DB) server 5 managing a DB. Here, an example where the DB server 5 is implemented by one computer is shown. However, it is possible to implement it by plural computers. In addition, the DB server 5 may manage not only one database, but also plural kinds of databases.

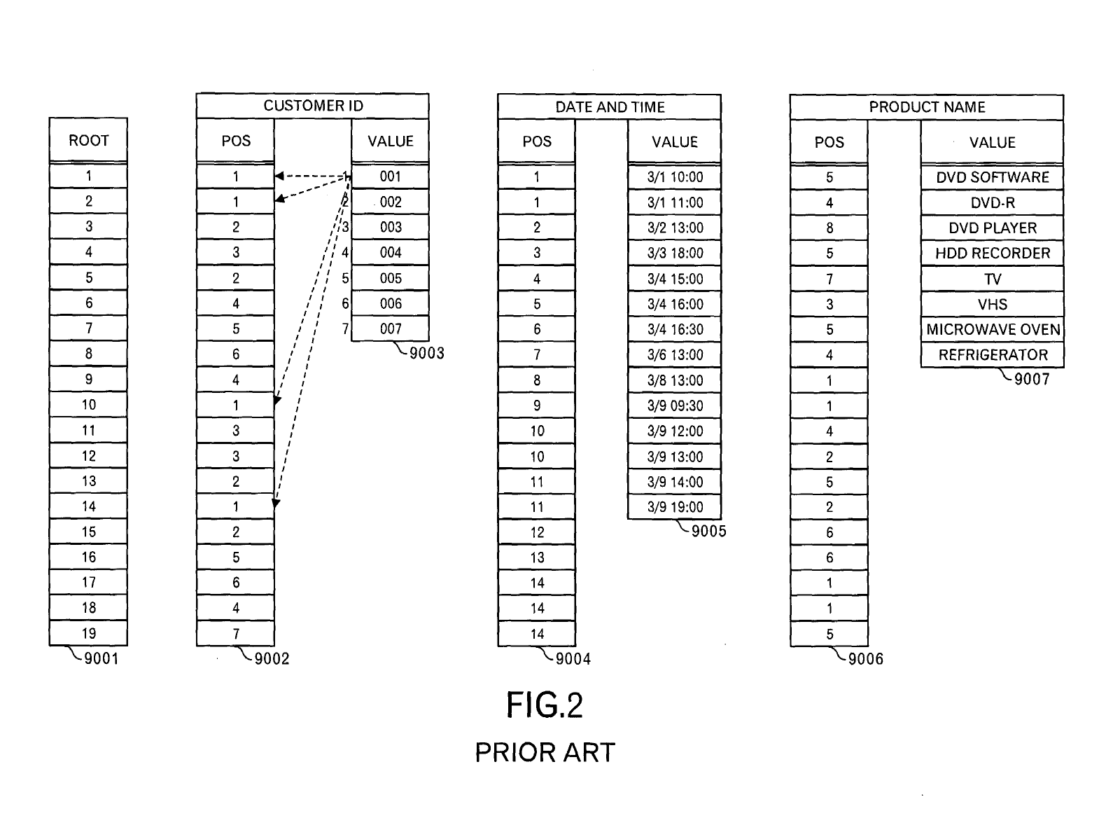

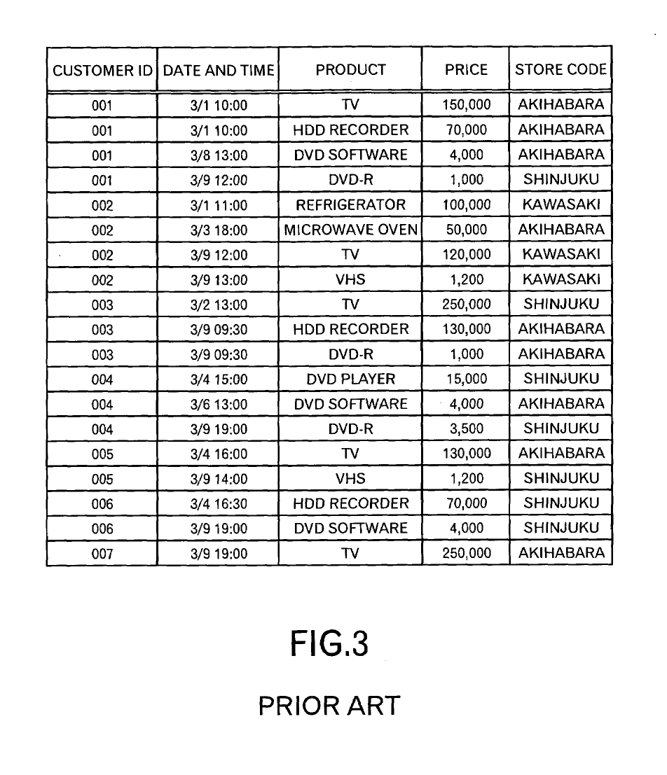

In this embodiment, it is supposed that the records are sorted. Therefore, the normal RDB is not practical in viewpoints of the processing speed and the storage capacity, and the data structure as shown in FIG. 2 (hereinafter, it is called FAST structure) is used for the data management. The data managed by the FAST structure is stored in the FAST structure data storage 56.

The DB server 5 includes a search instruction receiver 51 that receives search instructions from the user terminal 3 via the network 1, a search instruction data storage 52 that stores data relating to the search instructions received by the search instruction receiver 51, an event judgment processor 53 that carries out an event judgment processing by using the data stored in the search instruction data storage 52, an event management table storage 54 that stores a processing result of the event judgment processor 53, a search preprocessor 55 that carries out a processing by using the data stored in the search instruction data storage 52, the event management table storage 54 and the FAST structure data storage 56, an event history condition table storage 57 that stores an event history condition table that is a processing result by the search preprocessor 55, a sorting result storage 58 that stores data of a sorting result that is a processing result by the search preprocessor 55, a search processor 59 that extracts pertinent data by carrying out a search processing according to an instruction from the search preprocessor 55 by using the FAST structure data storage 56, the sorting result storage 58 and the event history condition table storage 57, a search result storage 60 that stores a processing result by the search processor 59, and a search result output unit 61 that outputs data stored in the search result storage 60 to the user terminal 3 of the requesting source. Incidentally, the search processor 59 includes a state transition manager 591 that carries out management of the state transitions based on settings by the search preprocessor 55.

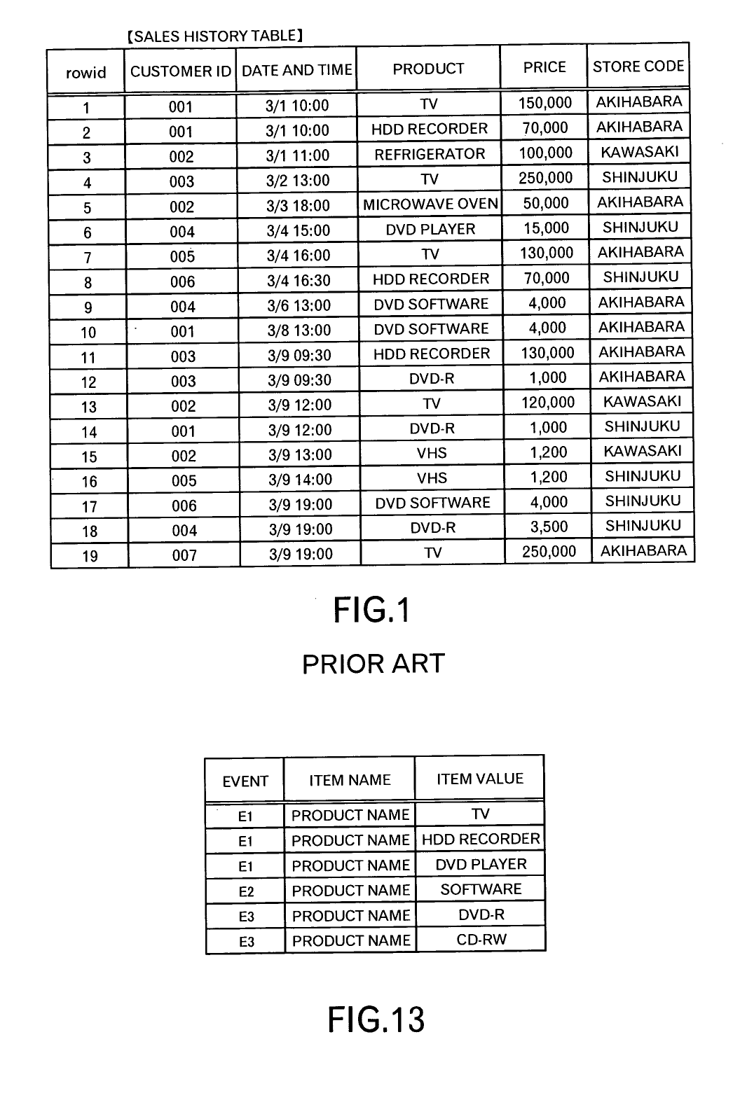

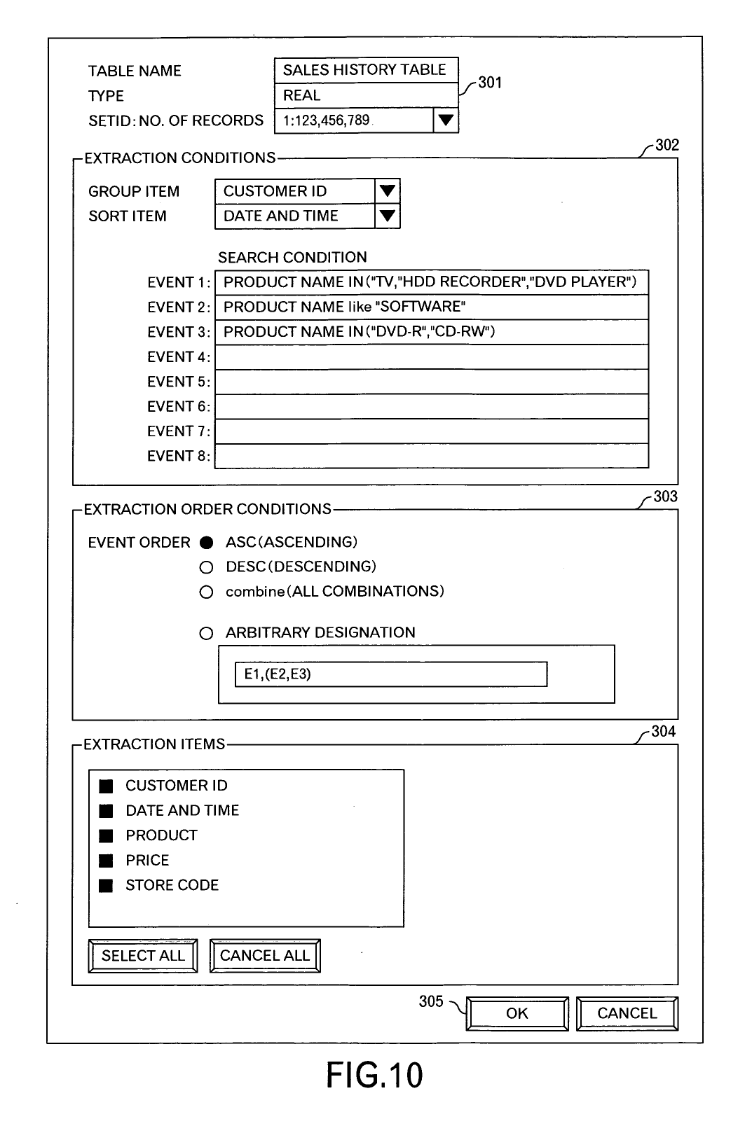

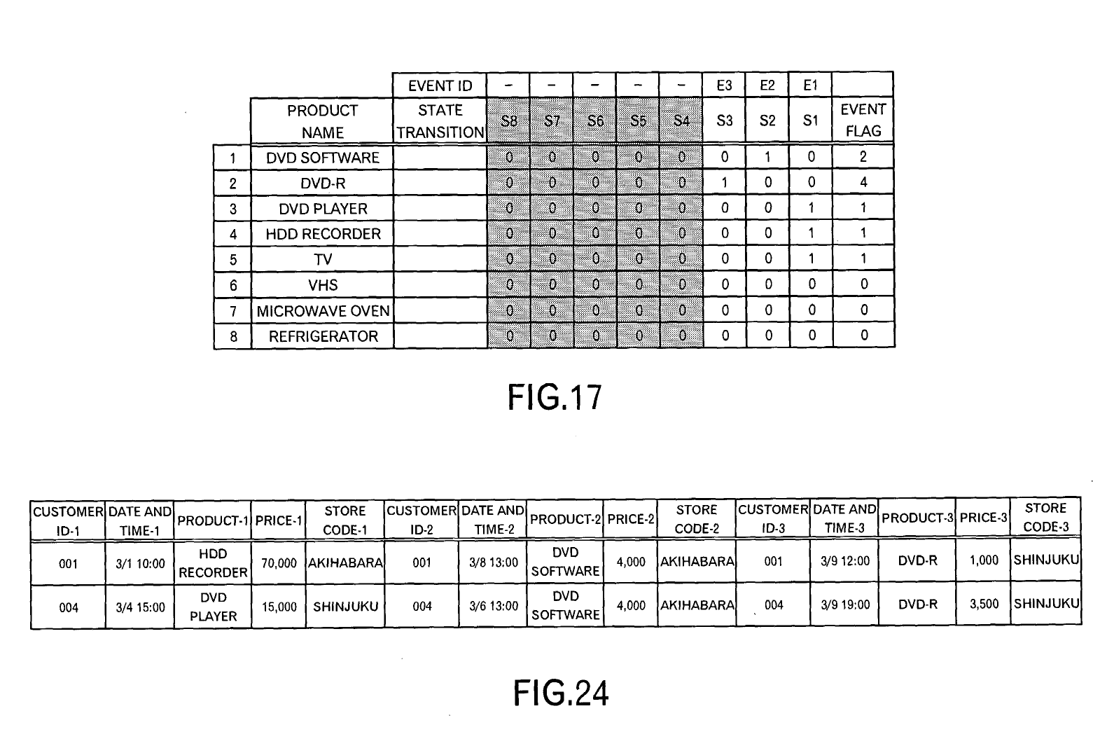

Next, an operation of the system shown in FIG. 9 will be explained by using FIGS. 10 to 24. Incidentally, the specific example described for the conventional art is used as it is for the description of this embodiment. That is, the data structure as shown in FIG. 2 is stored in the FAST structure data storage 56, and a search is considered to extract customers who purchased, first, “HDD recorder”, “DVD player” or “TV (Television)”, next purchased any “software”, and finally purchased “DVD-R” or “CD-RW”. Incidentally, the data according to the FAST structure holds the same content as the sales history table, as shown in FIG. 1.

First, the user of the user terminal 3 operates the user terminal 3 to access the DB server 5, and causes it to display an input screen of a search instruction on a display device. For example, a screen as shown in FIG. 10 is displayed on the display device. The screen example of FIG. 10 includes a display/designation column 301 of a name, a type and a start SET ID and the number of records of a table to be searched, an extraction condition designation column 302 to designate a group item to be grouped at the sorting, a sort item that is an item to be sorted, events that are search conditions, an event order condition designation column 303 to designate an order relationship among the events when plural events are designated in the extraction condition designation column 302, and an extraction item designation column 304 to designate items to be extracted with respect to the records meeting the search conditions. Incidentally, according to the conditions described above, in a column of the event 1, which is an extraction condition, it is designated as a condition that the product name is “TV”, “HDD recorder” or “DVD player”. Similarly, in a column of the event 2, it is designated as a condition that the product name is similar to “software”, and in a column of the event 3, it is designated as a condition that the product name is “DVD-R” or “CD-RW”. As for the event order, it is possible to designate “ascending order”, “descending order”, “all combinations (all sequences)”, “arbitrary designation” or the like. According to the conditions described above, the “ascending order” is selected. Incidentally, the “arbitrary designation” can designate various order conditions, and “E1, (E2, E3)” means the designations of the order “E1”, “E2” and “E3”, and the order “E1”, “E3”, and “E2”.

The user designates necessary conditions in the screen as shown in FIG. 10, and clicks an OK button 305. Then, the user terminal 3 accepts the instruction, and transmits input data as a search instruction to the DB server 5. The search instruction includes data to be searched, the extraction conditions (the group item, sort item and event group), the extraction order condition and extraction items. Incidentally, although it is not possible to designate in FIG. 10, other conditions can be added.

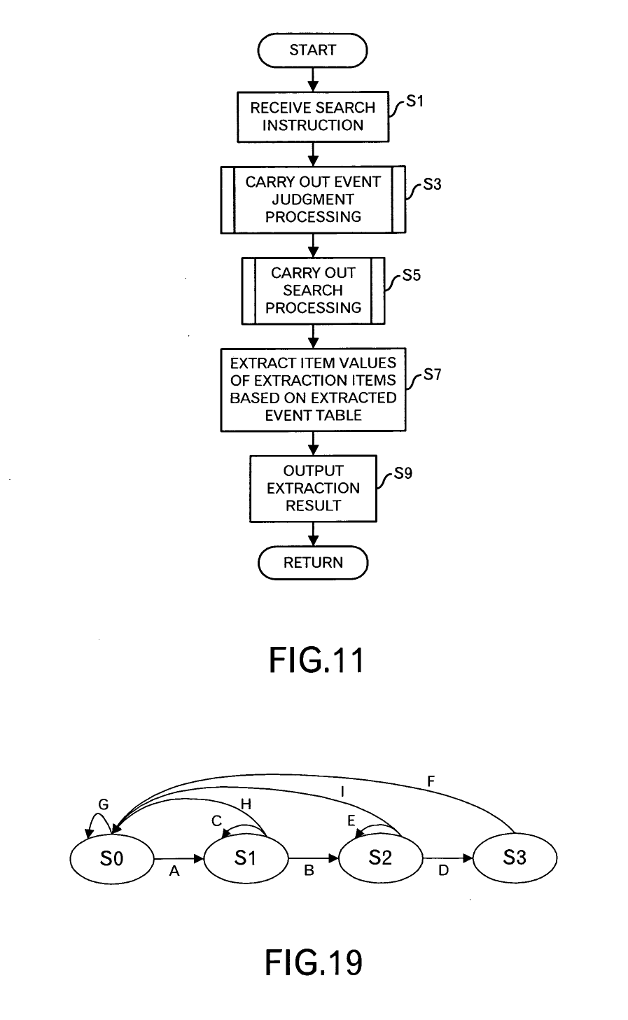

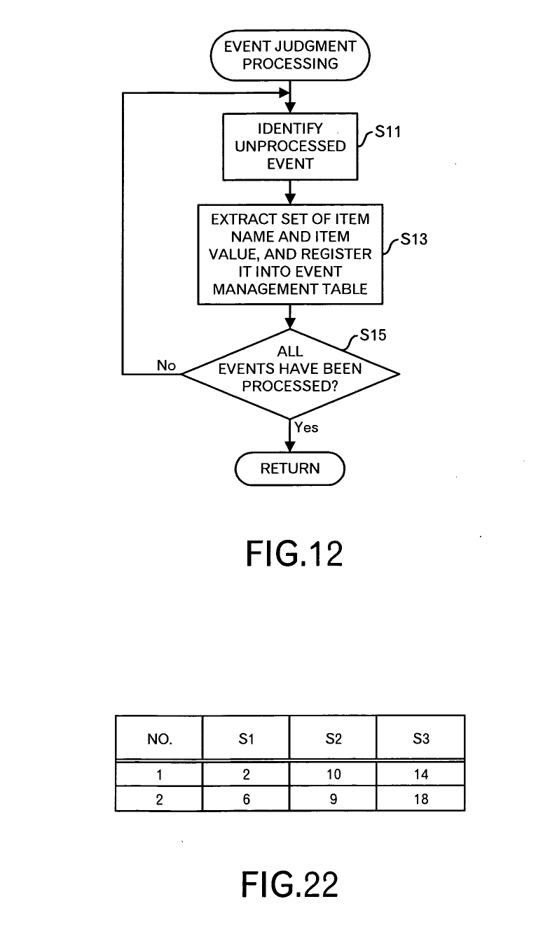

The search instruction receiver 51 of the DB server 5 receives the search instruction from the user terminal 3, and stores the data relating to the search instruction into the search instruction data storage 52 (FIG. 11: step S1). Then, the event judgment processor 53 uses the data relating to the search instruction, which is stored in the search instruction data storage 52, to carry out an event judgment processing (step S3). This event judgment processing will be explained by using FIGS. 12 and 13. First, the event judgment processor 53 identifies an unprocessed event among the events stored in the search instruction data storage 52 (step S11), extracts a set of the item name and the item value from the unprocessed event, and store the extracted set into the event management table (step S13). An example of the event management table stored in the event management table storage 54 is shown in FIG. 13. In the example of the event management table, an event, an item name and an item value are registered. Incidentally, even in the same event, there is a case where plural sets of the item name and the item value are designated. In such a case, data of plural lines is registered for the same event. In a case of the aforementioned specific conditions, data as shown in FIG. 13 is registered in the event management table.

Then, the event judgment processor 53 judges whether or not all events have been processed (step S15), and when any unprocessed event exists, the processing returns to the step S11. On the other hand, when all events have been processed, the processing returns to the original processing.

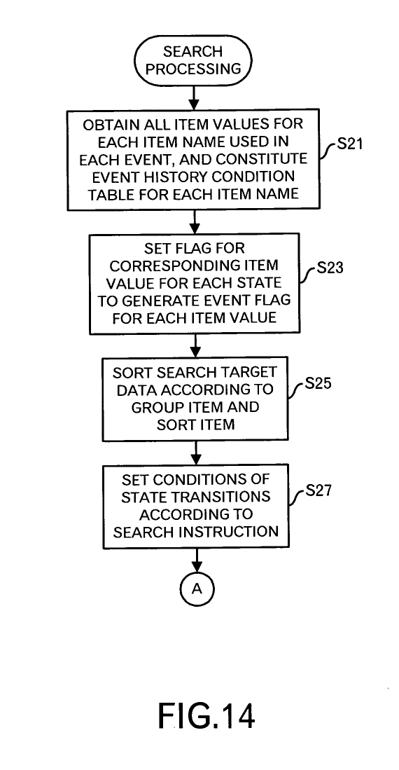

Returning to the explanation of FIG. 11, a search processing is carried out next (step S5). The search processing will be explained by using FIGS. 14 to 23.

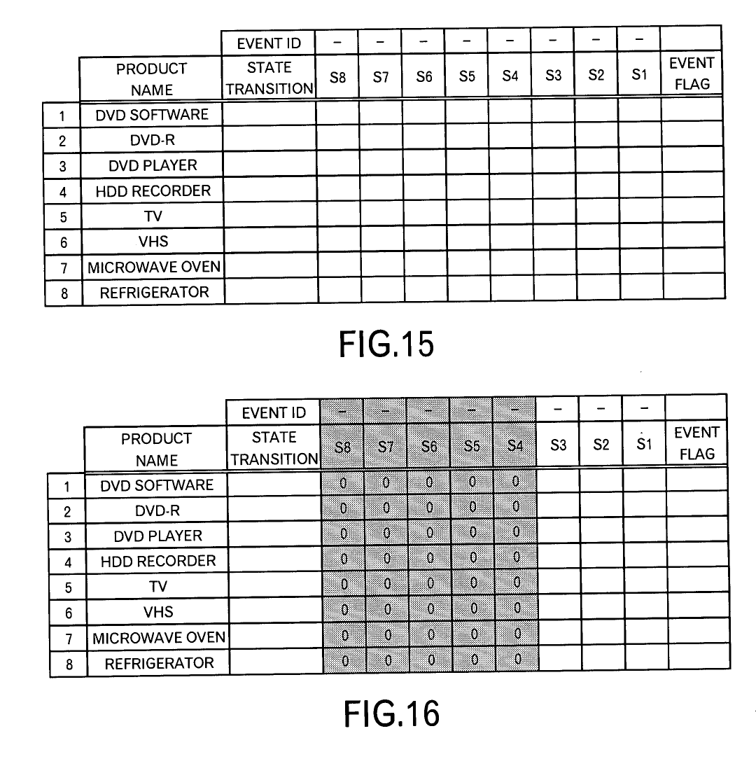

First, the search preprocessor 55 identifies an item name used in each event from the event management table stored in the event management table storage 54, obtains, for each identified item name, all item values from the FAST structure data storage 56, and configures an event history condition table for each identified item name (FIG. 14: step S21). Specifically, an example of the event history condition table is shown in FIG. 15. According to the aforementioned conditions, the item name is the “product name”. Therefore, the value table 9007 shown in FIG. 2 is obtained. The event history condition table shown in FIG. 15 includes lines for the item values included in this value table 9007, and also includes columns of states S1 to S8 to represent the state transitions, and a column of an event flag (FLG). Incidentally, the event history condition table also has a structure capable of associating the events stored in the event management table with the states.

Next, the search preprocessor 55 refers to the event management table in the event management table storage 54 and the search instruction data storage 52 to associate one event with one state, and sets a flag of a corresponding item value ON to generate the event flags for each item value (step S23).

The event order condition in the search instruction relating to the processing is stored in the search instruction data storage 52. According to this order condition, the event is associated with the state. According to the aforementioned conditions, because the event 1 (E1), the event 2 (E2) and the event 3 (E3) are searched in this order, the event 1 is associated with the state S1, the event 2 with the state S2, and the event 3 with the state S3. Then, they are stored into the event history condition table. When the processing is carried out by this step, the event history condition table becomes a state as shown in FIG. 16. Incidentally, because the states S4 to S8 are not associated with any events at this time, those portions are hatched in FIG. 16 and “0” is set to the flags for the states.

Furthermore, as for each state, ON is set to the flag of the corresponding item value. According to the aforementioned conditions, because “DVD player”, “HDD recorder” or “TV” is designated in the event 1 (E1), “DVD player”, “HDD recorder” and “TV” are identified as the corresponding item values. Moreover, “1” is set in the column of the state S1 corresponding to the event 1 and in the respective lines of “DVD player”, “HDD recorder” and “TV”, and “0” is set in the same column and in the other lines.

Incidentally, there is a case where the item value designated in the search condition is not completely identical to the item value actually registered in the database. In this embodiment, it is not judged for each record whether or not the item values are identical. Because it is judged at this stage whether or not the item value registered in the value table 9007 is identical to the item value designated in the search condition, the subsequent processing is simplified.

Similarly, because “Software” is designated in the event 2 (E2), “DVD software” is identified as the corresponding item value. Thus, in a case where there is no complete conformity, as compared with the conventional technique in which the comparison is carried out for each record, the subsequent processing in this embodiment becomes efficient. Then, “1” is set in the column of the state S2 corresponding to the event 2 and in the line “DVD software”, and “0” is set in the other lines.

Because “DVD-R” or “CD-RW” is designated in the event 3 (E3), only “DVD-R” is identified as the corresponding item value. Thus, in a case where the search condition including the completely different item value is designated, it is easily understood that the comparison for each record is much inefficient. Then, “1” is set in the column of the state S3 corresponding to the event 3 and in the line “DVD-R”.

Then, bits of the flags set from the state S1 to S8 are treated as a binary bit string. Incidentally, the earlier the order of the event, the lower bit “1” is set, and the later the order of the event, the higher bit “1” is set. Thus, according to the order of the event, the event flag is set. In a case where the same order is designated, even if the different item values are found, the same event flag is set. FIG. 16 indicates values converted into decimal values in the column of the event flag (FLG). However, the binary value is used.

Because the event history condition table is completed at this stage, data of this event history condition table is stored in the event history condition table storage 57. Incidentally, although it is described later, a table on behalf of the value table 9007 is required. Therefore, a table 501 is generated as shown in FIG. 18, and stored into the event history condition table storage 57.

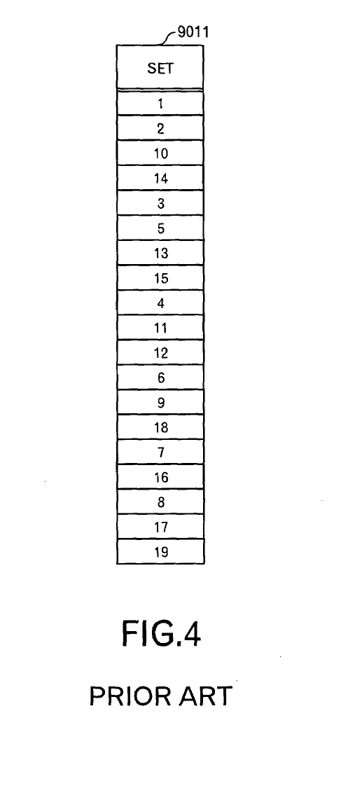

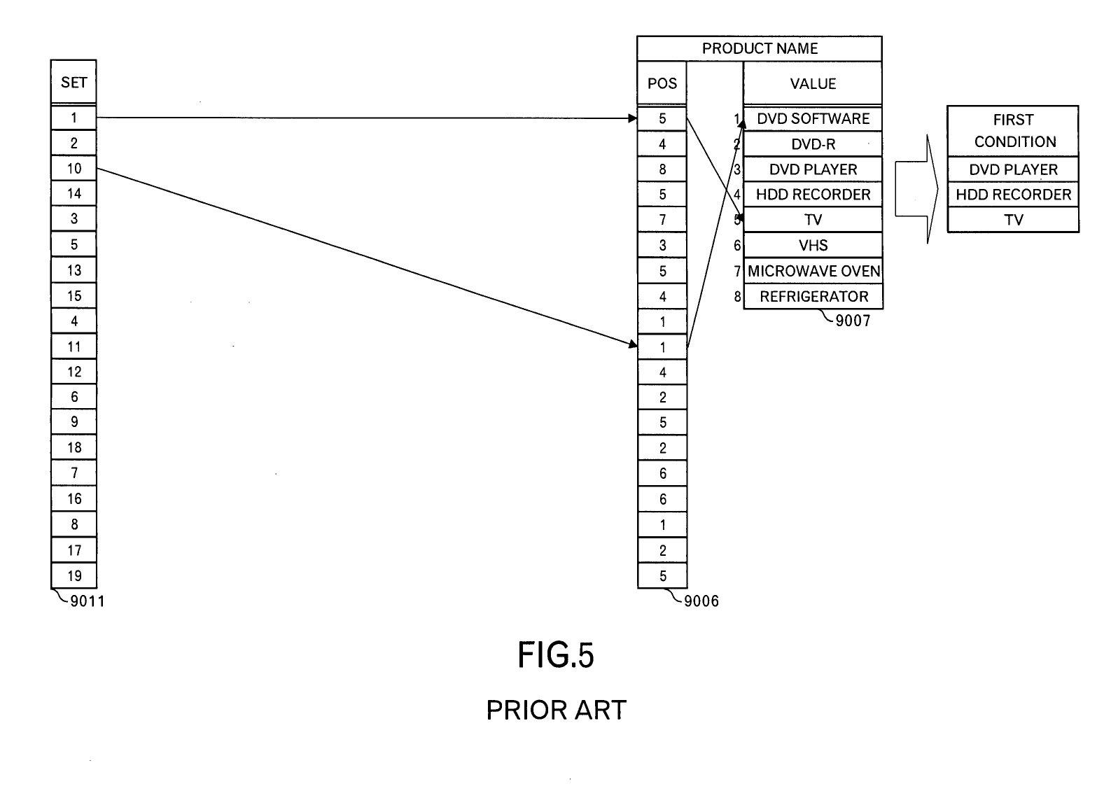

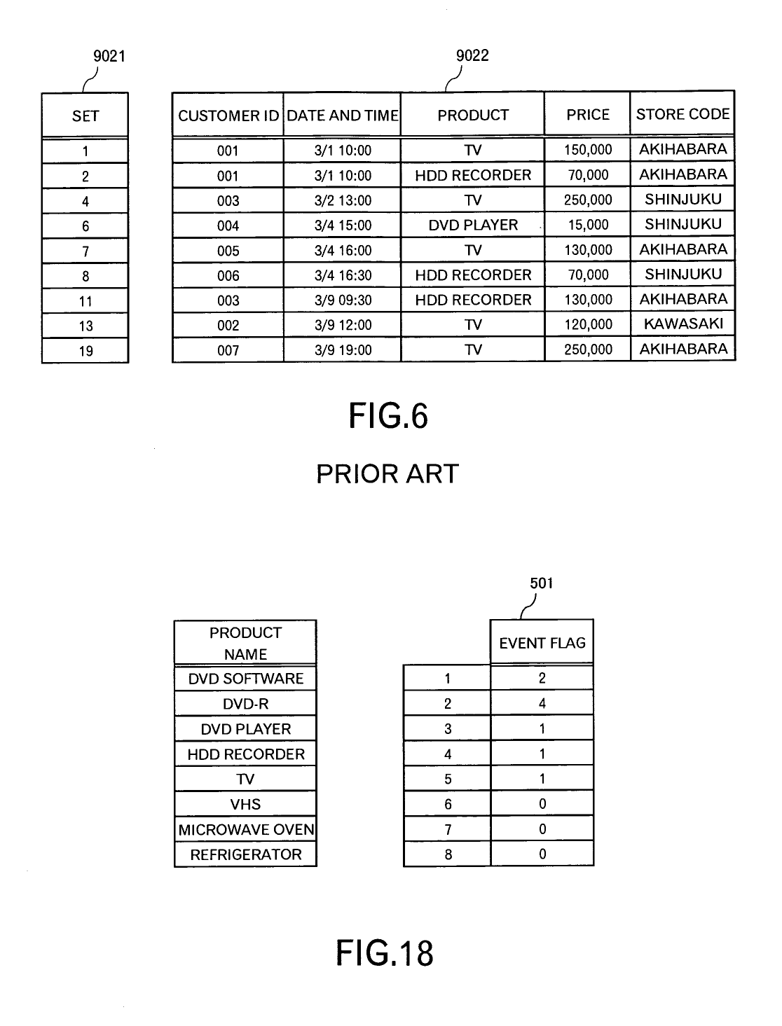

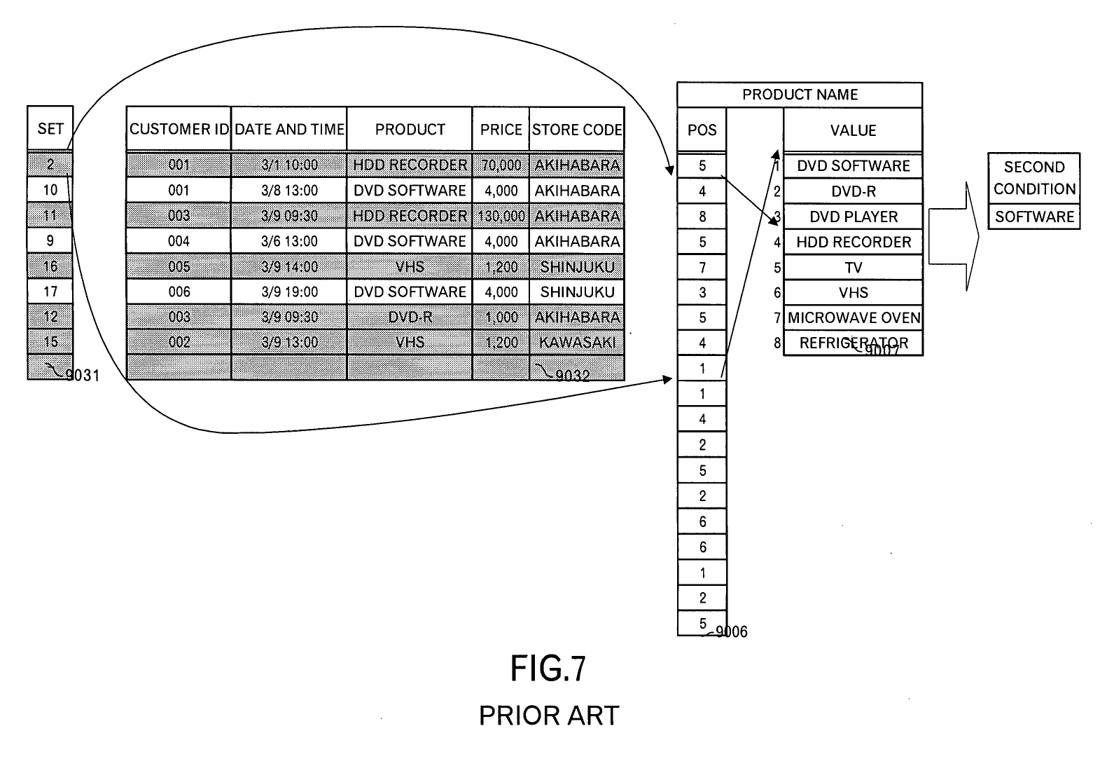

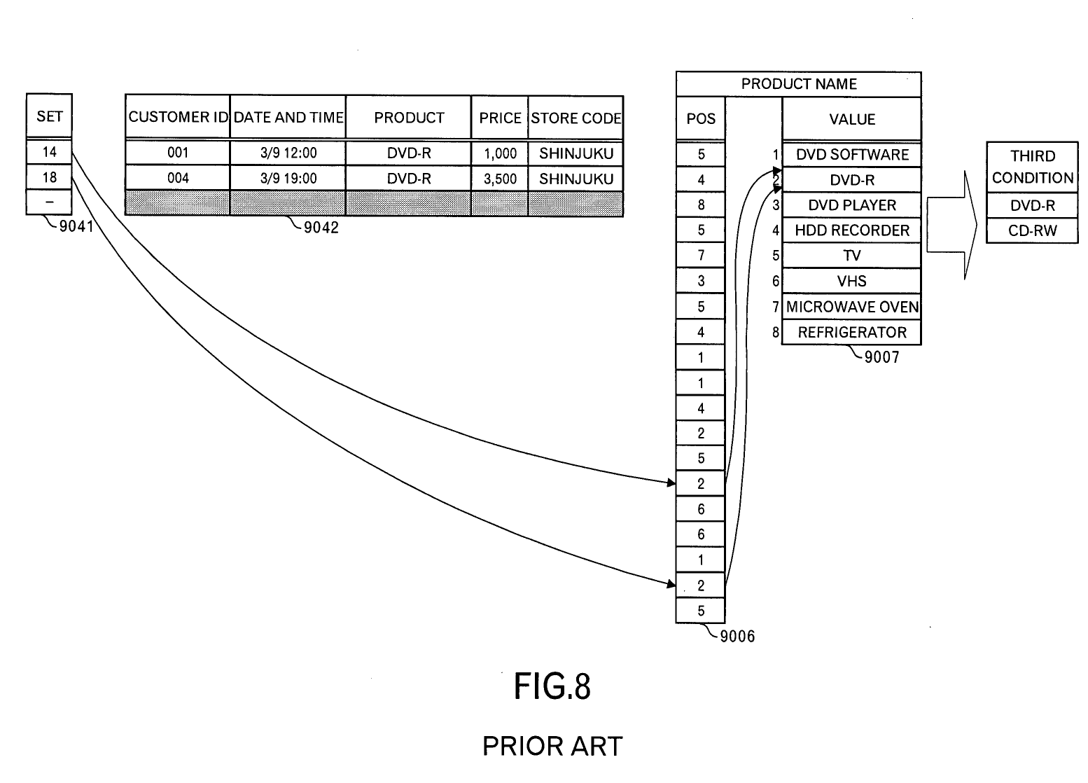

After that, the search preprocessor 55 refers to the FAST structure data storage 56, sorts search target data in the FAST structure according to the group item and the sort item, which are stored in the search instruction data storage 52, and stores the sorting result into the sorting result storage 58 (step S25). This processing itself is the same as the conventional technique. The data stored in the sorting result storage 58 is data as shown in FIG. 4.

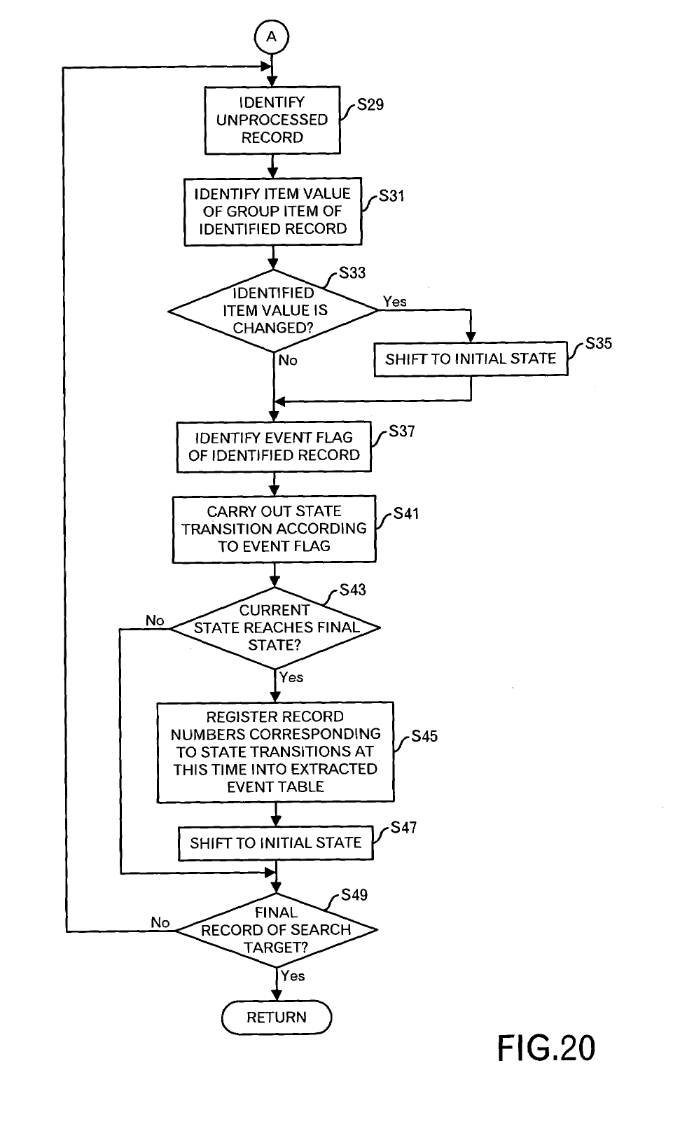

In addition, the search preprocessor 55 sets conditions of the state transitions into the state transition manager 591 according to the search instruction (step S27). Although the details are explained below, the conditions of the state transitions can be variously set. For example, as for the aforementioned specific example, there is a case where the conditions of the state transition should be set according to the intention of the searcher, such as a treatment in a case where the event 1 occurs after the event 1, a treatment in a case where any event other than the events 1 to 3 occurs after the event 1 and then the event 2 occurs, and the like. Here, when there is an instruction in the search instruction for a treatment in the case where any event other than the events 1 to 3 occurs after the event 1 and then the event 2 occurs or the like, the conditions of the state transitions are set into the state transition manager 591. There is a case where the step S27 is skipped because the default settings are used. Incidentally, because the number of states is determined according to the number of events, the setting of the number of states is always carried out. The processing shifts to a processing shown in FIG. 20 via a terminal A.

The states and the state transitions, which are managed by the state transition manager 591, will be explained by using FIG. 19. The required states are the states S1 to S3 and an initial state S0. Incidentally, the state S3 is identified as a final state. When the number of events increases, the number of states also increases, and when the number of events decreases, the number of states also decreases. Moreover, the state transitions include a state transition A from the initial state S0 to the state S1, which occurs when the search condition of the event 1 is satisfied, a state transition B from the state S1 to the state S2, which occurs when the search condition of the event 2 is satisfied, a state transition D from the state S2 to the state S3, which occurs when the search condition of the event 3 is satisfied, a state transition F from the state S3 to the initial state S0, which occurs when it is confirmed that the current state reaches the state S3 that is the final state, a state transition G from the initial state S0 to the initial state S0, which occurs the search condition of the event 1 is not satisfied in the initial state S0, a state transition C from the state S1 to the state S1, which occurs when the search condition of the event 1 is satisfied again in the state S1, a state transition E from the state S2 to the state S2, which occurs when the search condition of the event 2 is satisfied again in the state S2, a state transition H from the state S1 to the state S0, which occurs when the search condition of the event 1 or 2 is not satisfied in the state S1, and a state transition I from the state S2 to the state S0, which occurs when the search condition of the event 2 or 3 is not satisfied in the state S2. Thus, the state transition from the initial state to the final state through the intermediate states, the self transitions which occur when the state transition from and to a certain state other than the final state occurs, the state transition from the final state to the initial state when it is confirmed that the current state reaches the final state, and the state transitions to the initial state, which occur when any of the state transition to the next state and the self transition does not occur.

Incidentally, by setting the conditions of the self transitions and the state transition to the initial state according to the search instruction, the flexible extraction can be carried out. For example, it is possible to carry out a setting in which the self transition is carried out as long as the condition making the transition to the subsequent state is not satisfied. For example, when “HDD recorder”, “DVD software” and “DVD-R” are purchased in this order, the aforementioned conditions are satisfied. However, when “HDD recorder”, “refrigerator”, “DVD software” and “DVD-R” are purchased in this order, the aforementioned conditions are not satisfied. However, if the self transition occurs without shifting to the initial state, even when the record “refrigerator” is detected, it is judged that the aforementioned conditions are satisfied even in a case of the latter purchase history. That is, it becomes possible to extract customers who approximately carry out the target purchase history by broadly grasping the purchase history.

Next, the search processor 59 identifies an unprocessed record from the record (FIG. 4) stored in the sorting result storage 58 (FIG. 20: step S29). Then, it identifies an item value of the group item of the identified unprocessed record (step S31). By using the record number (SETID) of the identified unprocessed record, the item value number at a corresponding position is read out from the POS array 9002 for the customer ID, which is stored in the FAST structure data storage 56, and the item value is acquired from the value table 9003 based on the item value number.

Then, the search processor 59 judges whether or not the item value of the group item of the unprocessed record identified at the step S31 is changed (step S33). By holding the item value of the group item of the previously processed record, it is judged whether or not it is changed. This is because whether or not the search conditions are satisfied should be judged for the records whose group item has the same item value. Incidentally, when there is no previously processed record, it is judged that the change occurred.

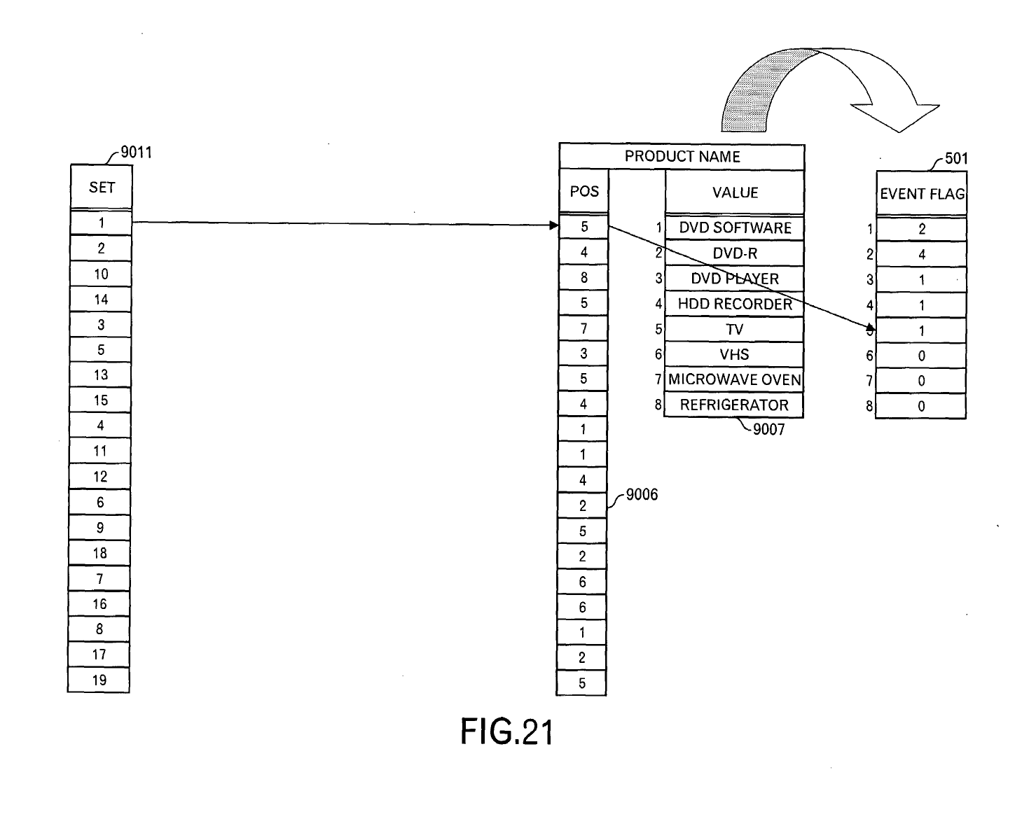

When it is judged that the change occurred, the search processor 59 causes the state transition manager 591 to carry out the state transition to the initial state S0 (step S35). After the step S35 or when it is judged that the item value of the group item is not changed, the search processor 59 identifies the event flag of the identified unprocessed record (step S37). This processing will be explained by using FIG. 21.

First, when the unprocessed record is identified from the SET array 9011 stored in the sorting result storage 58, the record number of the identified unprocessed record is identified. Then, the item value number at the record number is identified in the POS array 9006 for the product name, which is stored in the FAST structure data storage 56, and instead of the previous value table 9007, the event flag at the position of the item value number in the event flag table 501 is identified. When the SETID is “1”, it is identified that the item value number is “5” in the POS array 9006. However, “TV” is not identified from the value table 9007, and the event flag “1” (a binary value “00000001”) is identified from the event flag table 501.

Returning to the explanation of FIG. 20, the state transition manager 591 carries out the state transition according to the identified event flag (step S41). Incidentally, the record numbers (SETID) of the records relating to the state transition are held. The record numbers to be held may be limited to the record numbers of the records relating to the state transitions on the direct path from the initial state to the final state. In the example of FIG. 19, the record numbers of the records causing the state transitions A, B and D. Thus, there is a case where it is judged whether or not the specific state transition occurs.

What state transition occurs depends on what is the current state and what event flag is identified. In a case of the state and the transition as shown in FIG. 19, the state transition A from the initial state S0 to the state S1 occurs when, in the initial state, the event flag (the binary bit string) whose least significant bit (the 8th bit) is “1” is identified. The state transition B from the state S1 to the state S2 occurs when, in the state S1, the event flag whose 7th bit is “1” is identified. The state transition D from the state S2 to the state S3 occurs when, in the state S2, the event flag whose 6th bit is “1” is identified. The state transition C, which is the self transition in the state S1, occurs when the event flag whose least significant bit is “1” is identified. The state transition E, which is the self transition in the state S2, occurs when the event flag whose 7th bit is “1” is identified. The state transition F from the state S3 to the state S0 is managed in a processing described below, and the state transitions G, H and I occurs when any event flag other than the aforementioned event flags is identified. Incidentally, as described above, the self transition may occur according to another definition.

Thus, it is possible to judge whether or not the state transition occurs, by checking the current state and the predetermined bit of the event flag.

Returning to the explanation of FIG. 20, the state transition manager 591 judges whether or not the current state reaches the final state (step S43). In the example of FIG. 19, it is judged whether or not the current state reaches the final state S3. When it is judged that the current state does not reach the final state, the processing shifts to step S49. On the other hand, when it is judged that the current state reaches the final state, the state transition manager 591 registers the record number corresponding to the state transitions at this time into an extracted event table in the search result storage 60 (step S45). The extracted event table is as shown in FIG. 22, for example. That is, the extraction number (No.), the record number (SETID) making the state transition to the state S1, the record number making the state transition to the state S2, and the record number making the state transition to the state S3 are registered in the table. Then, the state transition manager carries out the state transition to the initial state S0 (step S47).

After the step S47, or when it is judged that the current state does not reach the final state, the state transition manager 591 judges whether or not the final record among the search target records has been processed (step S49). When there is an unprocessed record, the processing returns to the step S29. On the other hand, when the final record has been processed, the processing returns to the original processing.

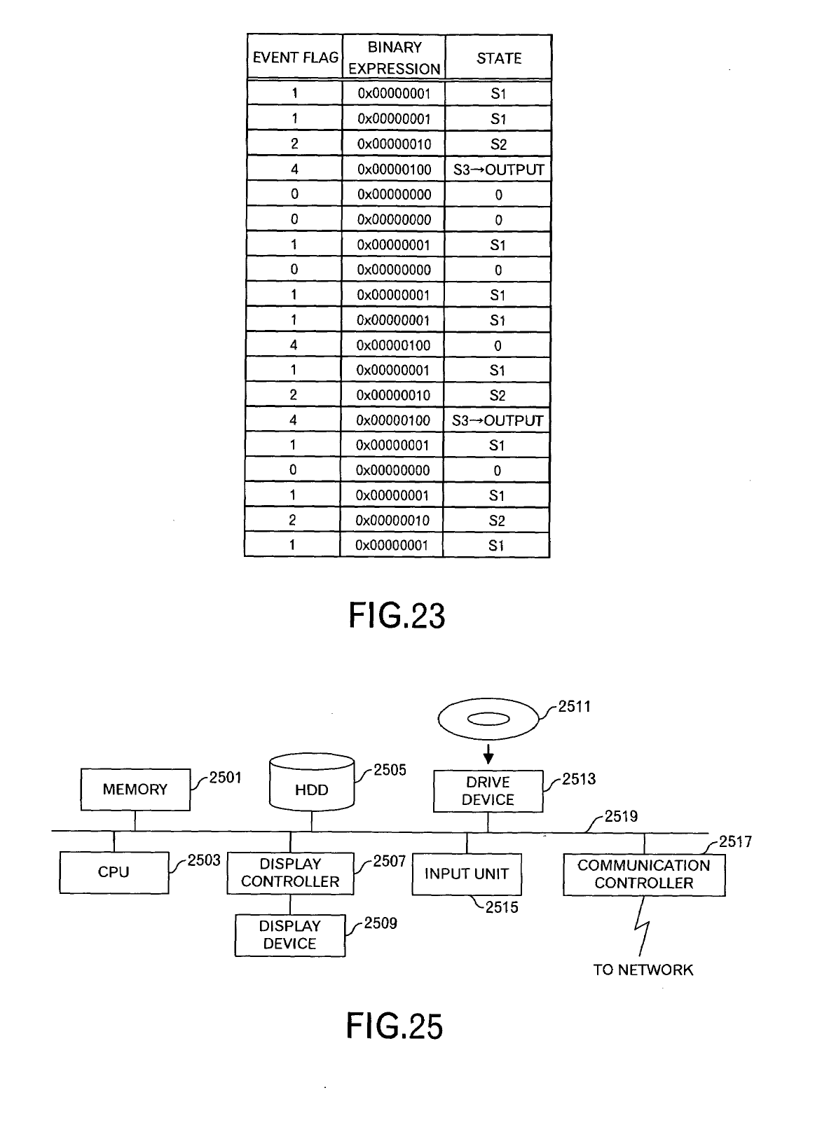

The processing progress of the steps S29 to S49 in a case where the sorting result as shown in FIG. 4 is obtained is summarized in FIG. 23. Because the event flag of the first record is “1” i.e. the least significant bit (the 8th bit) is “1”, the state transition from the initial state S0 to the state S1 occurs. Because the event flag of the second record is “1” i.e. the least significant bit is “1”, the self transition to the state S1 occurs. Because the event flag of the third record is “2”, i.e. the 7th bit is “1”, the state transition to the state S2 occurs. Because the event flag of the fourth record is “4”, i.e. the 6th bit is “1”, the state transition to the state S3 occurs. That is, because the current state reaches the final state, the record numbers of the 1st, 3rd and 4th records in the SET array 9011 in FIG. 4 are output. Incidentally, because the second record makes the self transition, the record numbers of the 2nd, 3rd and 4th records may be output. Then, the current state shifts to the initial state S0.

Incidentally, when the 5th record is processed, because the customer ID that is the group item is changed, the current state is forcibly shifted to the initial state S0. In addition, because the event flag of the 5th record is “0”, the self transition to the initial state S0 occurs. Because the event flag of the 6th record is “0”, the self transition to the initial state S0 occurs. Because the event flag of the 7th record is “1”, the state transition from the initial state to the state S1 occurs. Because the event flag of the 8th record is “0”, the state transition to the initial state S0 occurs.

Incidentally, when the 9th record is processed, because the customer ID that is the group ID is changed, the current state is forcibly shifted to the initial state S0. In addition, because the event flag of the 9th record is “1”, the state transition from the initial state S0 to the state S1 occurs. Because the event flag of the 10th record is “1,” the self transition to the state S1 occurs. Because the event flag of the 11th record is “4”, the state transition from the state S1 to the initial state S0 occurs.

Incidentally, when the 12th record is processed, because the customer ID that is the group item is changed, the current state is forcibly shifted to the initial state S0. In addition, because the event flag of the 12th record is “1”, the state transition from the initial state S0 to the state S1 occurs. Because the event flag of the 13th record is “2”, the state transition from the state S1 to the state S2 occurs. Because the event flag of the 14th record is “4”, the state transition from the state S2 to the state S3 occurs. That is, because the current state reaches the final state, the record numbers of the 12th, 13th and 14th record are outputted. Then, the current state shifts to the initial state S0.

Incidentally, when the 15th record is processed, because the customer ID that is the group item is changed, the current state is forcibly shifted to the initial state S0. In addition, because the event flag of the 15th record is “1”, the state transition from the initial state S0 to the state S1 occurs. Because the event flag of the 16th record is “0”, the state transition to the initial state S0 occurs.

Incidentally, when the 17th record is processed, because the customer ID that is the group item is changed, the current state is forcibly shifted to the initial state S0. In addition, because the event flag of the 17th record is “1”, the state transition from the initial state S0 to the state S1 occurs. Because the event flag of the 18th record is “2”, the state transition from the state S1 to the state S2 occurs.

Incidentally, when the 19th record is processed, because the customer ID that is the group item is changed, the current state is forcibly shifted to the initial state S0. In addition, because the event flag of the 19th record is “1”, the state transition from the initial state S0 to the state S1 occurs. However, because this record is the final record, the processing returns to the original processing.

Thus, the comparison between the item values are carried out only at the settings of the event flags, and during the processing for each record, the event flags are identified to judge whether or not the state transitions occurred according to the event flags occur along with the definition. As for the checking of the event flag, when the aforementioned flags are used, because it is only confirmed whether or not “1” is set at a predetermined position, the processing is highly simplified. Moreover, the processing for the records is limited to once for one record. Therefore, when the huge volume of the records should be processed, the processing load is reduced.

Returning to the explanation of FIG. 11, the search processor 59 extracts the item values of the extraction items stored in the search instruction data storage 52 based on the extracted event table in the search result storage 60, and stores them into the search result storage 60 (step S7). This processing is a processing in which, as shown in FIG. 2, the item value number is obtained at a corresponding position in the POS array of the item to be extracted, and the item values corresponding to the item value numbers are read out from the value table. When the customer ID, the date and time, the product name, the price and the store code should be extracted, data as shown in FIG. 24 is stored into the search result storage 60. Because the registration was carried out twice in the example of FIG. 23, the two sets, each including three records, are extracted and stored.

Then, the search result output unit 61 reads out the search result stored in the search result storage 60, and outputs the read search result to the user terminal 3 of the requesting source (step S9). The user terminal 3 receives data of the search result from the DB server 5, and displays the data on the display device. For example, when the data as shown in FIG. 24 is displayed on the display device, the user can grasp data meeting the search instruction.

By carrying out the aforementioned processing, the speed of the entire search processing is improved, and it is possible to treat various search instructions.

Although one embodiment of this invention has been described, this invention is not limited this embodiment. For example, the functional block diagram of the DB server 5 shown in FIG. 9 is mere an example, and does not always correspond to an actual program module configuration.

In addition, as for the processing flow, as long as the processing result is the same, it is possible to execute in parallel or change the order of the steps. For example, the sorting processing can be carried out in earlier stage of the search processing, and because the sorting processing needs much time, the sorting processing may be executed by other processor in parallel.

In addition, the setting method of the event flags is not limited to the aforementioned method, and it is possible to set the event flags in other modes. For example, when the occurrences of the state transitions can be merely grasped, appropriately, it is not necessary to shift the bit position in the binary bit string, and the different value may be merely adopted. Moreover, when the number of state transitions is large, it is possible to use the event flag over 8 bits.

In addition, in the aforementioned specific example, the group item is designated. However, the group item is not always designated. Moreover, although the sorting is carried out in time sequence in the aforementioned example, the sort item is not only the date and time, but also other item may be designated. In addition, the search item is only the product name in the aforementioned specific example. It is possible to designate plural search items. Furthermore, it is possible to designate only an OR condition for the same search item in the same event, but it is possible to designate an AND condition for a relationship between different search items. When the AND condition is used, the event flag is separately designated for each search item, and the state transition is judged based on combinations of the plural event flags. For example, in a case where an event in which the product name is “TV” and its price is “more than 50000 Yen” is defined, when a combination of a flag for the product name “TV” and a flag for the price “more than 50000 Yen” occurs, it is judged, in that case, that the search conditions relating to the event are satisfied. For example, even when a combination of the flag A and a flag X is identified, the same state transition does not occur, in that case. That is, it is possible to flexibly deal with the search conditions by appropriately defining the state transitions.

Incidentally, the client terminal 3 and/or DB server 5 are computer devices as shown in FIG. 25. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A search processing method, comprising:
assigning a flag for each item value of a specific item based on a search instruction including a plurality of ordered search conditions, each said search condition designating a specific value for said specific item, and storing said flags as flag definition data into a storage device;
sorting a plurality of records to be searched, which are stored in a database, according to a predetermined rule;
identifying a flag corresponding to an item value of said specific item in each said record to be processing in order of said plurality of sorted records, by using said flag definition data stored in said storage device;
in a process of said identifying said flag in said order of said plurality of sorted records, judging whether or not an appearance mode of the identified flags follows said search instruction; and
outputting data of said records relating to said flags included in said appearance mode of said flags, which was judged to follow said search instruction.

2. The search processing method as set forth in claim 1, wherein said assigning comprises:
identifying an item value of said specific item, which corresponds to said specific value of said specific item in a specific search condition and is included in said record of said database; and
assigning a flag according to said order of said specific search condition to the identified item value.

3. The search processing method as set forth in claim 1, wherein said judging comprises:
judging, according to the identified flags, whether or not a transition between states defined according to said order occurs; and
judging whether or not a final state is reached when said transition between said states occurs.

4. The search processing method as set forth in claim 1, wherein said predetermined rule is a condition including sorting for each group item designated by said search instruction, and sorting in time sequence order, and
said judging is carried out by each range of a same item value of said group item.

5. The search processing method as set forth in claim 1, wherein said database has a table holding a relationship between an item value number uniquely identifying an item value and said item value, and an item value number designating information array storing information designating said item value number in order of said records.

6. The search processing method as set forth in claim 1, wherein said flag is a bit string in which “1” is set at a bit position of said order of the corresponding search condition.

7. The search processing method as set forth in claim 1, wherein said identifying said flag is carried out only once for said plurality of records to be searched, which are stored in said database.

8. A search processing program embodied on a medium, said search processing program comprising:
assigning a flag for each item value of a specific item based on a search instruction including a plurality of ordered search conditions, each said search condition designating a specific value for said specific item, and storing said flags as flag definition data into a storage device;
sorting a plurality of records to be searched, which are stored in a database, according to a predetermined rule;
identifying a flag corresponding to an item value of said specific item in each said record to be processing in order of said plurality of sorted records, by using said flag definition data stored in said storage device;
in a process of said identifying said flag in said order of said plurality of sorted records, judging whether or not an appearance mode of the identified flags follows said search instruction; and
outputting data of said records relating to said flags included in said appearance mode of said flags, which was judged to follow said search instruction.

9. The search processing program as set forth in claim 8, wherein said assigning comprises:
identifying an item value of said specific item, which corresponds to said specific value of said specific item in a specific search condition and is included in said record of said database; and
assigning a flag according to said order of said specific search condition to the identified item value.

10. The search processing program as set forth in claim 8, wherein said judging comprises:
judging, according to the identified flags, whether or not a transition between states defined according to said order occurs; and
judging whether or not a final state is reached when said transition between said states occurs.

11. The search processing program as set forth in claim 8, wherein said predetermined rule is a condition including sorting for each group item designated by said search instruction, and sorting in time sequence order, and
said judging is carried out by each range of a same item value of said group item.

12. A search processing apparatus, comprising:
a flag assigning unit that assigns a flag for each item value of a specific item based on a search instruction including a plurality of ordered search conditions, each said search condition designating a specific value for said specific item, and storing said flags as flag definition data into a storage device;
a unit that sorts a plurality of records to be searched, which are stored in a database, according to a predetermined rule;
a unit that identifies a flag corresponding to an item value of said specific item in each said record to be processing in order of said plurality of sorted records, by using said flag definition data stored in said storage device;
a judging unit that judges, in a process of identifying said flag in said order of said plurality of sorted records, whether or not an appearance mode of the identified flags follows said search instruction; and
a unit that outputs data of said records relating to said flags included in said appearance mode of said flags, which was judged to follow said search instruction.

13. The search processing apparatus as set forth in claim 12, wherein said flag assigning unit comprises:
a unit that identifies an item value of said specific item, which corresponds to said specific value of said specific item in a specific search condition and is included in said record of said database; and
a unit that assigns a flag according to said order of said specific search condition to the identified item value.

14. The search processing apparatus as set forth in claim 12, wherein said judging unit comprises:
a unit that judges, according to the identified flags, whether or not a transition between states defined according to said order occurs; and
a unit that judges whether or not a final state is reached when said transition between said states occurs.
